(19) United States
(12) Patent Application Publication
(10) Pub. No.: US 2015/0265984 A1
(43) Pub. Date: Sep. 24, 2015

(54) Manual Magnetic Mixer

(71) Applicant: Tony Prada, Los Angeles, CA (US)

(72) Inventor: Tony Prada, Los Angeles, CA (US)

(21) Appl. No.: 14/332,220

(22) Filed: Jul. 15, 2014

Related U.S. Application Data
(60) Provisional application No. 61/969,684, filed on Mar. 24, 2014.

(51) Int. Cl. B01F 13/08; B01F 3/08; B65D 25/20

(52) U.S. Cl. CPC B01F 13/08; B65D 25/20; B01F 3/0815

(57) ABSTRACT

A cleanser dispenser having a container, an inner magnet, an outer magnet, is disclosed. Liquid cleansers without emulsifying agents tend to separate into two phases, a thick hydrophobic top phase and a more fluid hydrophilic bottom phase. To create a dispensable cleanser without chemical emulsifiers, a user can manually disrupt and mix the two phases together by moving an outer magnet along the outside of the container, which attracts an inner magnet disposed within the container. As the inner magnet moves along the inner surface of the container, the thick top phase breaks apart and becomes suspended within the bottom phase, thereby creating a uniform hydrophobic and hydrophilic liquid cleanser suspension that can easily be pumped through a liquid cleanser dispenser. The inner magnet may have one or more protrusions to aid in breaking apart the thick hydrophobic top phase.

### CROSS-REFERENCE TO RELATED APPLICATIONS

This patent application claims the benefit of U.S. Provisional Patent Application No. 61/969,684, filed on Mar. 24, 2014, fully incorporated herein by reference in its entirety.

### FIELD OF THE DISCLOSURE

The present invention relates to a system for disrupting suspensions in a container. Specifically, the system disrupts two immiscible phases that form during soap or cleanser production, so that the resulting suspension can be poured or pumped easily from a soap dispenser.

### BACKGROUND OF THE INVENTION

Chemical emulsifiers are used by manufacturers to reduce surface tension between two immiscible phases such as two different liquid phases or a liquid and a solid phase. However, there are rising health risk concerns about the use of chemical emulsifiers. Various emulsifiers have been shown to cause allergic reactions, skin irritation, respiratory problems, and if ingested, may cause nausea, abdominal pain, and diarrhea.

Soap is generally made by mixing a triglyceride (such as animal fat or vegetable oils) with a caustic soda (such as lye). The reaction produces glycerin and soap. When certain types of liquid soaps or cleansers are made, the resulting product often separates into a clear bottom liquid portion (usually a high density hydrophilic composition) and a top opaque solid or thick liquid portion (usually a lower density hydrophobic composition having various fats and oils). Hydrophobic and hydrophilic compositions do not mix well together and separate into two phases, even after mixing. Creating a uniform suspension having both hydrophobic and hydrophilic portions therefore remains a challenge.

Chemical emulsifiers have been used by manufacturers to reduce surface tension between two immiscible phases, and the use of chemical emulsifiers is one way to create a uniform liquid soap suspension having both hydrophobic and hydrophilic substances. The use of physical, non-chemical, emulsifying techniques are not generally sufficient to thoroughly mix the hydrophobic and hydrophilic substances into a pumpable or pourable suspension. For example, magnetic stir bars have been used to mix substances through the use of an outer electrically controlled spinning magnet, and an inner magnet within a container having multiple substances.

In the magnetically controlled electric stir bar systems, as the outer magnet rotates, an inner stir bar within the container rotates along with the outer magnet. This rotation creates a vortex in the container, thereby mixing the difference substances together. However, this technique has its limitations because the inner magnetic stir bar must remain at the bottom of the container since the inner magnet is magnetically coupled to a magnet housed in a tabletop device. Magnets in these systems therefore cannot easily mix substances that float, stick to container walls, or are generally immiscible because the magnet in the container remains only at the bottom of the container. Therefore, there is a need to find alternative ways to create suspensions of liquid soaps and cleansers that do not use chemical emulsifiers to create more environmentally friendly cleansers.

### BRIEF SUMMARY OF THE PRESENT INVENTION

The embodiments of the present invention are directed to a system and method for mixing immiscible phases. When making soaps, a top immiscible hydrophobic phase and a bottom immiscible hydrophilic phase form when oils are react with lye to form soap. Other skin cleansers contain components that separate out in solution into different phases and adhere to the side walls of the container These phases do not naturally form uniform suspensions without chemical emulsifiers. It is an object of the present invention to create a uniform liquid cleansing or soap suspension without using chemical emulsifiers. The uniform suspension should be pumpable or pourable from a liquid soap dispenser.

In a first embodiment, a soap dispenser has an inner magnet, an outer magnet, and a container. The container has a body surrounding a well. The body has an inner surface, an outer surface, a bottom region, a middle region, and top region. The inner magnet is disposed within the well of the container and the outer magnet is disposed on the outer surface of the container. The outer magnet is designed to attract the inner magnet to the inner surface of the container. The inner magnet can be moved to the bottom, middle or top region of the container as the user moves the outer magnet among the different regions on the outer surface of the bottom, middle, or top region of the container. As the inner magnet moves along the inner surfaces, the magnet will break apart, agitate, disrupt, and/or dislodge the hydrophobic immiscible material, thereby forming a liquid soap suspension that previously separated into two distinct phases that could not both be pumped through a liquid soap dispenser.

In some embodiments, the magnet has a substantially flat first end, a middle region and a second end. There may be one or more protrusions on the inner magnet, or attached to the inner magnet. These protrusions aid in breaking apart solid substances in the liquid soap suspension. The protrusions may be on one of the ends of the magnet, the sides of the magnet, or both the sides and end of the magnet.

In another embodiment, the invention comprises an outer stirring member, and an inner stirring member. The outer and inner stirring member can be magnets, but they can also be a magnetic or magnetizable member. It is not required that both inner and outer stirring members both be magnets magnets, but could be made typically of magnetic iron. In one embodiment the outer member could be a magnet and the inner member could be a magnetic member, or vice versa.

Another object of the invention is a method of creating a liquid soap suspension. The method involves the steps of: placing the outer magnet on the outer surface of the container, attracting the inner magnet to the outer magnet, and moving the outer magnet along the outer surface of the container. The movement of the outer magnet along the outer surface of the container moves the inner magnet along the inner surface of the container because the inner and outer magnets are magnetically coupled to each other. The movement of the inner magnet disrupts the top immiscible phase (which may be comprised of various oil substances), and the continued movement of the inner magnet between the top immiscible phase and bottom immiscible phase (which may be a water based substance, such as glycerin) mixes the two phases together, thereby creating a uniform suspension.

In one embodiment, the user moves the magnet along the bottom, middle, and top regions of the container in order to thoroughly break apart, dislodge and mix the two phases together.

### BRIEF DESCRIPTION OF THE DRAWINGS

FIG. 1 is cross sectional view of an embodiment of an outer magnet on the left and three variants of inner magnets on the right, separated by the soap dispenser wall.

FIG. 2 is a cross sectional view of a soap dispenser having an inner and outer magnet when the soap is separated into a top phase and a bottom phase.

FIG. 3 is a cross sectional view of the soap dispenser of FIG. 2 after the user moves the magnets and mixes the top and bottom phases together to create a uniform liquid soap suspension.

### DETAILED DESCRIPTION OF EMBODIMENTS

The following discussion addresses a number of embodiments and applications of the present disclosure. Reference is made to the accompanying drawings that form a part hereof, and are shown by way of illustration of specific embodiments in which the disclosure may be practiced. It is to be understood that other embodiments may be utilized and changes may be made without departing from the scope of the present disclosure.

The beneficial features of the present disclosure will be evident from the described embodiments. It is to be understood that the present disclosure is not limited to such specific application and that numerous implementations of the present disclosure may be realized.

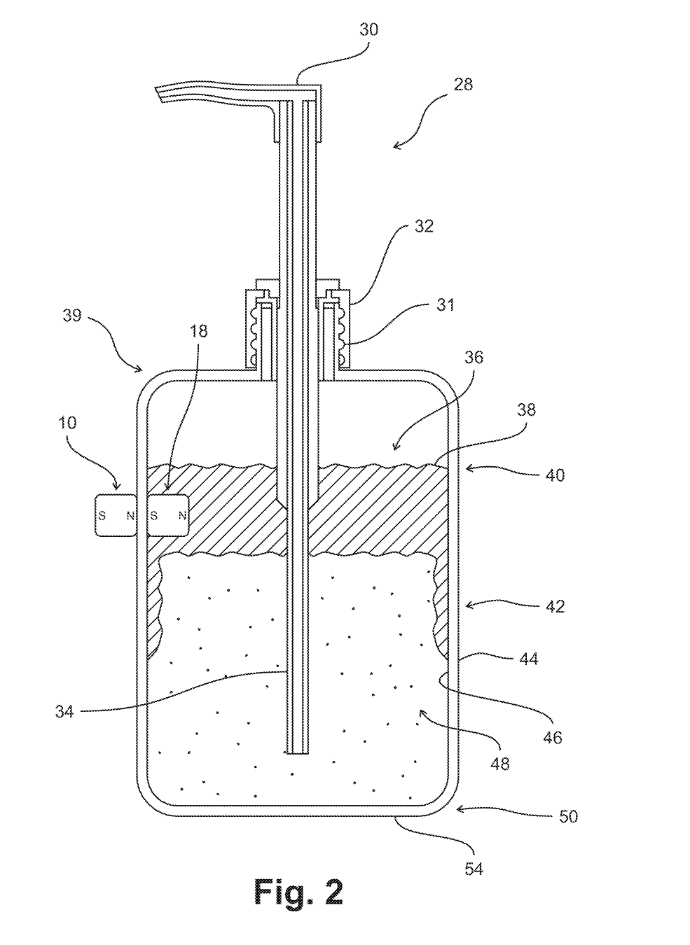

FIG. 2 illustrates a cross section of a liquid soap dispenser. While the figure illustrates a liquid soap dispenser 28, the present invention may be used any number of kinds of containers that are able to hold liquids. The liquid soap dispenser 28 has a soap dispenser head 30, a pump base 32, and a soap dispenser straw 34 that draws up liquids when the head 30 is pressed down. Various embodiments of soap dispensers are known by those having skill in the art and may also be used. In this embodiment, the pump base 32 attaches to the neck 31 of the container 28. The container 28 has a body 39 forming the side walls and base 54 of the container 28, the inner receptacle of the body 39 forming a well 36, which holds the liquid soap. When liquid soap is created without emulsifiers and hydrophobic and hydrophilic components are added, these compositions will separate into a solid or viscous portion 38, and a liquid portion 48. Examples of ingredients used to create a natural cleansers that forms immiscible layers include formulae having ingredients such as purified water, volcanic ash, organic dates, organic honey, organic fennel, organic myrrh, organic bee pollen, royal jelly, and propolis extract. Many other ingredients may be used in combination to create natural cleansing formulas.

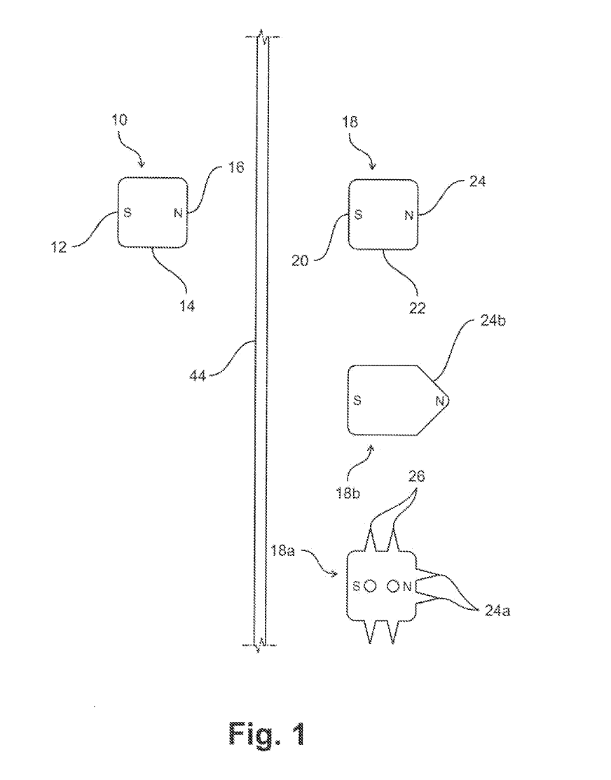

Disposed within the well 36 is an inner magnet 18. The inner magnet 18 is attracted to an outer magnet 10 on the outside of the body 39 of the container capable of being moved around by a user. The magnets 10, 18 may be shaped in a variety of ways. FIG. 1 illustrates a few embodiments of magnets that have advantageous properties to create a uniform soap suspension. The outer magnet 10 or inner magnets 18, 18a, 18b may be cylindrically or rectangularly shaped (shown in cross section in FIG. 1) or any shape that permits the two magnets 10, 18 to track each other. The outer magnet 10 has a first end 12 having a south pole, a middle region 14, and a second end 16 having a north pole. The inner magnet 18 also has a first end 20 having a south pole, a middle region 22, and a second end 24 having a north pole.

The inner magnet may be shaped so that there are protrusions on its second end 24. The second end 24 of the inner magnet maybe be substantially flat 24, have multiple protrusions 24a, or a single protrusion 24b. In addition to the second end 24, 24a, 24b of the inner magnet 18, 18a, 18b having protrusions, the side(s) of the magnet may have side protrusions 26 to help break apart any solid or thick liquid substances that the magnet 18a, 18b engages. The protrusions should preferably not be magnetic or capable of attracting a magnet because the protrusions should project inward or sideward to break up viscous material rather than be attracted to the outer magnet. The protrusion should be integral with the inner magnet 18a, 18b with the non-magnetic attachments. The magnets 10, 18 may be of any size but the outer magnet 10 should be of sufficient size so that it can be easily grasped and moved with one hand, and the inner magnet is of sufficient size that it is large enough to be able to mix the contents of the well 36. Magnet lengths between approximately 1 cm and 5 cm are likely sufficient to accomplish the objects of the invention, but other sizes may work as well.

Although the outer magnet 10 and inner magnet 18, 18a, 18b are illustrated as both being magnetic, the object of the invention would still be satisfied if the invention comprised an outer stirring member 10 and an inner stirring member 18, 18a, 18b were a magnetic and magnetizable member (but not a magnet itself). It is not required that both stirring members 10, 18, 18a, 18b, both be magnets. The magnet could be composed typically of magnetic iron. The outer stirring member 10 could be a magnet and the inner stirring member 18, 18a, 18b could be a non-magnet but made from a metal attracted to the outer stirring magnet 10, or vice versa. In this system, the user can move the outer stirring member 10 in the same manner as in the previously described embodiment, and have the same effect of mixing the two phases 38, 48 of the soap to create a more uniform suspension.

Turning attention now to the method of creating a suspension, the user grasps the outer magnet 10 and moves it to a location on the outer surface 44 of the body 39 near the inner magnet 18. When the inner magnet 18 is sufficiently close to the outer magnet, the inner magnet 18 is magnetically drawn to the inner surface of the soap dispenser body 39. When the user moves the outer magnet 10, the inner magnet 18 correspondingly moves along the inner surface 46 of the body 39, disrupting the solid portion and mixing the solid portion into a useable soap suspension. As shown in FIG. 2, the inner magnet 18 has been drawn to the upper region 40 of the container body where the hydrophobic phase 38 is located. The user can then move the outer magnet 10 along all the inner surfaces 46 of the body 39, including the top region 40, middle region 42, bottom region 50, and base 54 of the body 39 of the soap dispenser 28. Moving magnets along all these different surfaces is not possible in magnetic mixers where the outer magnet is housed within a base device that rests on a counter.

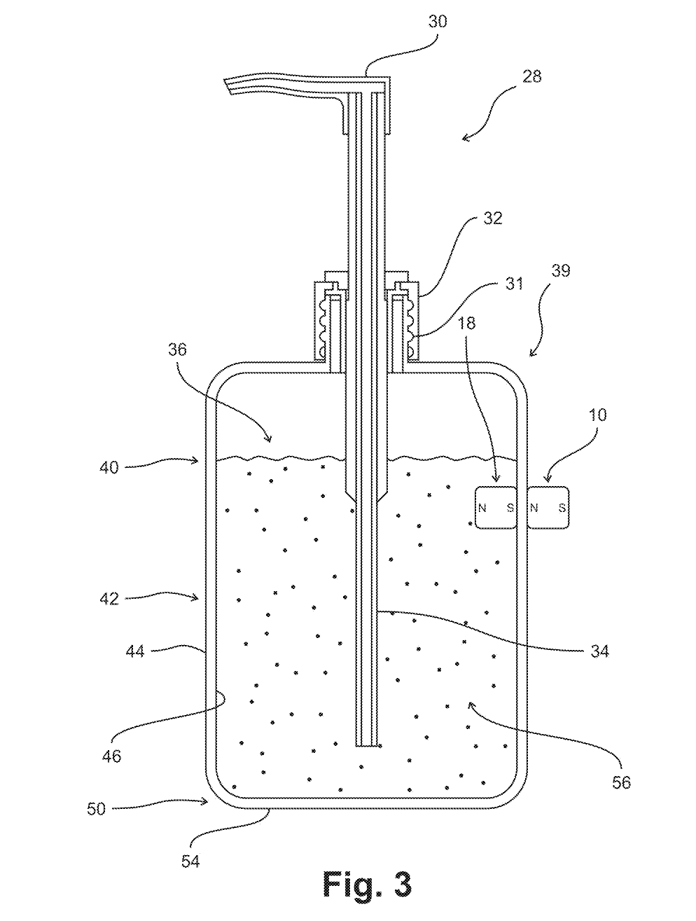

After sufficient agitation and disruption of the top phase 38 by the inner magnet 18, a more uniform suspension 56 of hydrophobic and hydrophilic compositions is created, as depicted in FIG. 3, compared to the pre-mixing stage shown in FIG. 2 where the hydrophobic phase 38, and hydrophilic phase 48, are separated into two layers.

Over time, without emulsifiers, the suspension 56 may again separate into two layers 38, 48. If this occurs, the user can easily re-suspend the soap by repeating the process of moving the outer magnet 18 along the outer surface 44 of the body 39 when the inner magnet 18 is magnetically attached to it. Moving the magnets may not be sufficient to fully mix the two layers 38, 48 together. To further assist with mixing after the magnets have broken up the ingredients adhering to the walls, the user may shake the container to suspend two layers 38, 48 together. It is advantageous to detach the outer magnet 10 from the outer wall so that the inner magnet 18 is no longer attracted to the inner wall of the container. Without magnetic attraction, the inner magnet 18 is free to move anywhere within the container body 39. By allowing the inner magnet 18 to travel freely within the container 10, the inner magnet 18 can act as an agitator to further mix substances within the container body 39 when shaken.

The specific embodiments described and illustrated should not be understood as limiting the present invention to the precise embodiments and illustrations. For example, although the embodiments have been described as relating primarily to soap and cleanser suspensions, it is to be understood that the device and methods would be able to suspend immiscible layers of non-soap substances. It is intended that the scope of the present invention not be limited by this detailed description, but by the claims and the equivalents to the claims appended hereto

I Claim:

1. A dispenser for dispensing a suspension comprising:
a) an inner magnet;
b) an outer magnet; and,
c) a container having a well and a body, the body having an inner surface, an outer surface, a bottom region, a middle region, and a top region;
said inner magnet disposed within said well of said container;
said outer magnet disposed on said outer surface of said container;
said outer magnet designed to attract said inner magnet to said inner surface, said bottom region, said middle region, and said top region of said container; and,
said outer magnet capable of being moved manually along said outer surface, said bottom region, said middle region, and said top region of said container.

2. The dispenser of claim 1, wherein said inner magnet is characterized as having a substantially flat first end, a middle region, and a second end.

3. The dispenser of claim 2, wherein said inner magnet is characterized as having at least one protrusion designed to increase disruption of an immiscible phase as said inner magnet moves within said container.

4. The dispenser of claim 3, wherein said inner magnet is characterized as having at least one protrusion extending from at least one of said middle region at least one protrusion from said second end.

5. The dispenser of claim 2, wherein said inner magnet is characterized has having as a plurality of protrusions designed to increase disruption of a top immiscible phase as said inner magnet moves within said container.

6. The dispenser of claim 1, wherein the container is a liquid soap container.

7. The dispenser of claim 1, wherein said inner magnet and said outer magnet are each between approximately 1 cm and 5 cm in length.

8. The dispenser of claim 3, wherein the at least one protrusion is not a magnet.

9. A dispenser for dispensing a suspension comprising:
a) an inner magnet;
b) an outer magnet; and,
c) a container having a well and a body, the body having an inner surface, an outer surface, a bottom region, a middle region, and a top region,
said inner magnet disposed within said well of said container;
said outer magnet disposed on said outer surface of said container;
said outer magnet designed to attract said inner magnet to said inner surface, said bottom region, said middle region, and said top region of said container;
said outer magnet capable of being moved manually along said outer surface, said bottom region, said middle region, and said top region of said container;
wherein said inner magnet has a first end and a second end, said first end substantially flat, said second end having at least one protrusion for increased disruption of a top immiscible phase.

10. A dispenser for dispensing a suspension comprising:
a) an outer stirring member;
b) an inner stirring member;
c) a container having a well and a body, the body having an inner surface, an outer surface, a bottom region, a middle region, and a top region,
said inner stirring member disposed within said well of said container;
said outer stirring metallic member disposed on said outer surface of said container;
wherein at least one of said outer stirring member and said inner stirring member is a magnet and at least one of said outer stirring member and said inner stirring member is a magnetizable member;
said outer stirring member is designed to attract said inner stirring member to said inner surface, said bottom region, said middle region, and said top region of said container;
said inner stirring member capable of being moved manually along said outer surface, said bottom region, said middle region, and said top region of said container.

11. The dispenser of claim 10, wherein said inner stirring member is characterized as having a substantially flat first end, a middle region, and a second end.

12. The dispenser of claim 10, wherein said outer stirring member magnet is characterized as having at least one protrusion designed to increase disruption of an immiscible phase as said inner magnet moves within said container.

13. A method of creating a liquid cleanser suspension, the method comprising:
a) placing an outer magnet on an outer surface of a container;
b) attracting an inner magnet disposed within said container to said outer magnet, said container having a top immiscible phase and a bottom immiscible phase;
c) moving said outer magnet along said outer surface of a container;
d) disrupting said top immiscible phase disposed within said container;
e) mixing said top and bottom immiscible phase, thereby creating substantially uniform suspension.

14. The method of claim 13, wherein moving said outer magnet is characterized as moving said outer magnet along at least two of a top region, a middle region, and a bottom region of said container.

15. The method of claim 13, wherein said inner magnet is characterized as having at least one protrusion designed to increase disruption of said top immiscible phase as said inner magnet moves within said container.

16. The method of claim 13, wherein said top immiscible phase is a hydrophobic phase.

17. The method of claim 13, further comprising the step of:
shaking the container, thereby further suspending said top and bottom immiscible phases.

18. The method of claim 13, further comprising the steps of:
detaching said outer magnet from said outer surface of the container, thereby permitting said inner magnet to detach from said inner surface of the container; and,
shaking the container, thereby permitting said inner magnet to move freely within a body of the container to act as an agitator to further mix the solution therein.
